(19) United States
(12) Patent Application Publication
(10) Pub. No.: US 2001/0055651 A1
(43) Pub. Date: Dec. 27, 2001

(54) PROCESS FOR THE TREATMENT OF TEXTILE MATERIALS WITH AN ANTIMICROBIAL AGENT

(76) Inventors: JIANWEN MAO, GRENZACH-WYHLEN (DE); MARCEL SCHNYDER, BIRSFELDEN (CH)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 09/168,416

(22) Filed: Oct. 8, 1998

(30) Foreign Application Priority Data
Oct. 13, 1997 (EP) 97810767.0
Jul. 15, 1998 (EP) 98810677.9

(51) Int. Cl. B05D 1/18; B05D 5/00

(52) U.S. Cl. 427/434.6; 427/430.1

(57) ABSTRACT

A process for the incorporation of an antimicrobial agent into a fibre, fabric or piece goods is described comprising treating said material by passing said fibre into an aqueous liquor containing an antimicrobial agent selected from (a) halogeno-o-hydroxydiphenyl compounds; (b) phenol derivatives; (c) benzyl alcohols; (d) chlorohexidine and derivatives thereof; (e) C₁₂-C₁₄ alkylbetaines and C₈-C₁₈ fatty acid amidoalkylbetaines; (f) amphoteric surfactants; (g) trihalocarbanilides; (h) quaternary and polyquaternary compounds; and (i) thiazole compounds.

The present invention relates to a process for the treatment of textile materials with anti-microbial agents, formulations comprising the antimicrobial agent and the textile material treated by this process.

There is an increasing demand for textiles exhibiting antimicrobial properties. Antimicrobial textile finishing in the form of a surface treatment of the textiles is already known, for example in U.S. Pat. No. 4,408,996. Such applications provide the treated textiles with antimicrobial activity, but the efficacy is not long-lasting, since the presence of the antimicrobial which is only available on the surface of the textiles, decreases after washing. A more advantageous method incorporates the antimicrobials into the fibre melt during the melt spinning step, preferably within the macromolecular structure. This method enables the antimicrobials to be built into the fibres and to migrate onto the surface of the fibres/textiles to provide long lasting efficacy, depending on the nature of the polymers involved. The efficacy can often last as long as the life-cycle of the relevant textile materials.

Unfortunately, for some materials, such as polyethylene terephthalate (PET), polybutylene terephthalate, polypropylene, nylon (including nylon-6, nylon-66), poly(m-phenylene iso-phthalamide), poly(p-phenylene terephthalamide), a thermal process at very high temperatures (>280° C.) is often involved in the melt spinning step of the fibre making process. Nonwoven textile materials can also be prepared from such a process. Because of the high temperatures, it is not feasible to directly incorporate antimicrobials, especially organic antimicrobials, into the molten polymers required for the fibre production process. At such temperatures, organic antimicrobials tend to decompose or vaporise.

It is therefore desired to find a process in which antimicrobials are incorporated into the macromolecular structure of such fibres, without using a thermal process at extremely high temperature.

Surprisingly, it was found that this object can be achieved in a simulated dyeing process.

The present invention, therefore, relates to a process for the incorporation of an antimicrobial agent into a fibre, fabric or piece goods comprising treating said material by passing said fibre into an aqueous liquor containing an antimicrobial agent selected from

(a) halogeno-o-hydroxydiphenyl compounds;

(b) phenol derivatives;

(c) benzyl alcohols;

(d) chlorohexidine and derivatives thereof;

(e) C₁₂-C₁₄ alkylbetaines and C₈-C₁₈ fatty acid amidoalkylbetaines;

(f) amphoteric surfactants;

(g) trihalocarbanilides;

(h) quaternary and polyquaternary compounds; and

(i) thiazole compounds.

Preferably, the antimicrobial agent (a) is selected from compounds of the formula

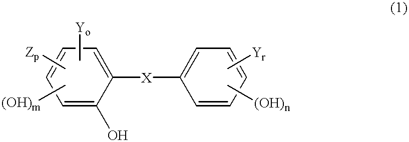

wherein

X is oxygen, sulfur or —CH₂—,

Y is chloro or bromo,

Z is SO₂H, NO₂ or C₁-C₄—Alkyl,

r is 0 to 3,

o is 0 to 3,

p is 0 or 1,

m is 0 or 1 and

n is 0 or 1;

and at least one of r or o is ≠0.

Preferably, in the present process, antimicrobial agents (a) of formula (1) are used, wherein

X is oxygen, sulfur or —CH₂—, and

Y is chloro or bromo,

m is 0,

n is 0 or 1,

o is 1 or 2,

r is 1 or 2 and

p is 0.

Of particular interest as antimicrobial agent (a) is a compound of formula

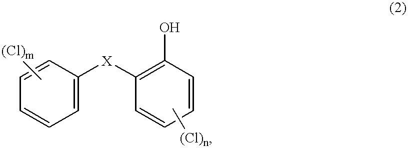

wherein

X is —O—or —CH₂—;

m is 1 to 3; and

n is 1 or 2, and most preferably a compound of formula

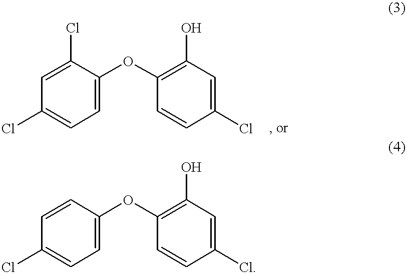

Preferred phenol derivatives (b) correspond to formula

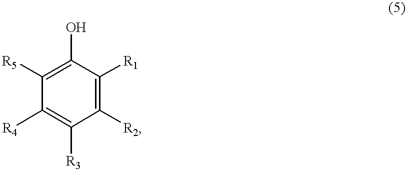

wherein

R₁ is hydrogen, hydroxy, C₁-C₄alkyl, chloro, nitro, phenyl or benzyl,

R₂ is hydrogen, hydroxy, C₁-C₆alkyl or halogen,

R₃ is hydrogen, C₁-C₆ alkyl, hydroxy, chloro, nitro or a sulfo group in the form of the alkali metal salts or ammonium salts thereof,

R₄ is hydrogen or methyl, and

R₅ is hydrogen or nitro.

Such compounds are typically chlorophenols (o-, m-, p-chlorophenols), 2,4-dichlorophenol, p-nitrophenol, picric acid, xylenol, p-chloro-m-xylenol, cresols (o-, m-, p-cresols), p-chloro-m-cresol, pyrocatechin, resorcinol, orcinol, 4-n-hexylresorcinol, pyrogallol, phloroglucine, carvacrol, thymol, p-chlorothymol, o-phenylphenol, o-benzylphenol, p-chloro-o-benzylphenol and 4-phenolsulfonic acid.

Typical antimicrobial agents (c) correspond to the formula

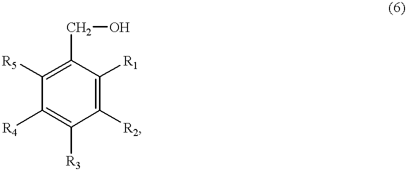

wherein R₁, R₂, R₃, R₄ and R₅ are each independently of one another hydrogen or chloro.

Illustrative examples of compounds of formula (5) are benzyl alcohol, 2,4-, 3,5- or 2,6-dichlorobenzyl alcohol and trichlorobenzyl alcohol.

Antimicrobial agent (d) is chlorohexidine and salts thereof, for example 1,1′-hexamethylene-bis-(5-(p-chlorophenyl)-biguanide), together with organic and inorganic acids and chlorhexidine derivatives such as their diacetate, digluconate or dihydrochloride compounds.

Antimicrobial agent (e) is typically C₈-C₁₈ cocamidopropylbetaine.

Amphoteric surfactants as antimicrobial agents (f) are suitably C,₁₂ alkylaminocarboxylic and C₁-C₃alkanecarboxylic acids such as alkylaminoacetates or alkylaminopropionates.

Typical trihalocarbanilides which are useful as antimicrobial agent (g) are compounds of the formula

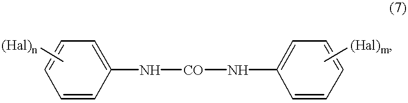

wherein

Hal is chloro or bromo,

n and m are 1 or 2, and

n+m are3.

The quaternary and polyquaternary compounds which correspond to antimicrobial agent (h) are of the formula

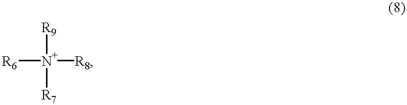

wherein R₆, R₇, R₈ and Rg are each independently of one another C₁-C₁₈alkyl, C₁-C₁₈alkoxy or phenyl-lower alkyl, and

Hal is chloro or bromo.

Among these salts, the compound of formula

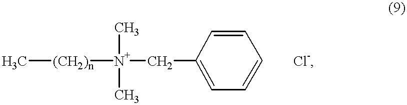

wherein n is an integer from 7 to 17, is very particularly preferred.

A further exemplified compound is cetyl trimethylethyl ammonium bromide.

Of particular interest as antimicrobial agent (i) is methylchloroisotahazoline.

The antimicrobial agents which are used in the present process are water-soluble or only sparingly soluble in water. In the present aqueous formulation they may therefore be applied as aqueous formulation in diluted, solubilised, emulsified or dispersed form.

If the antimicrobial agents are applied in dispersed form they are milled with an appropriate dispersant, conveniently using quartz balls and an impeller, to a particle size of 1-2mm.

Suitable dispersants for the antimicrobial agents in the present process are:

acid esters or their salts of alkylene oxide adducts, typically acid esters or their salts of a polyadduct of 4 to 40 mol of ethylene oxide with 1 mol of a phenol, or phosphated polyadducts of 6 to 30 mol of ethylene oxide with 1 mol of 4-nonylphenol, 1 mol of dinonylphenol or, preferably, with 1 mol of compounds which are prepared by addition of 1 to 3 mol of unsubstituted or substituted styrenes to 1 mol of phenol,

polystyrene sulfonates,

fatty acid taurides,

alkylated diphenyl oxide mono- or disulfonates,

sulfonates of polycarboxylates,

the polyadducts of 1 to 60 mol of ethylene oxide and/or propylene oxide with fatty amines, fatty acids or fatty alcohols, each containing 8 to 22 carbon atoms in the alkyl chain, with alkylphenols containing 4 to 16 carbon atoms in the alkyl chain, or with trihydric to hexahydric alkanols containing 3 to 6 carbon atoms, which polyadducts are converted into an acid ester with an organic dicarboxylic acid or with an inorganic polybasic acid,

ligninsulfonates, and, most preferably,

formaldehyde condensates such as condensates of ligninsulfonates and/or phenol and formaldehyde, condensates of formaldehyde with aromatic sulfonic acids, typically condensates of ditolyl ether sulfonates and formaldehyde, condensates of naphthalenesulfonic acid and/or naphthol- or naphthylaminesulfonic acids with formaldehyde, condensates of phenolsulfonic acids and/or sulfonated dihydroxydi-phenylsulfone and phenols or cresols with formaldehyde and/or urea, as well as condensates of diphenyl oxide-disulfonic acid derivatives with formaldehyde.

In the dispersion the concentration of the antimicrobial agents is from 0.1%-30%, preferably 2-10% b.w..

But for some antimicrobials with low melting points, i.e., <80° C., such a milling process would prove to be difficult in industrial scale. Also such a process would cause a significant increase in production costs.

Surprisingly, a method for preparing antimicrobials in aqueous form without undergoing milling processes was found and proved efficient. The antimicrobial agents can be applied in solubilized form without undergoing milling processes.

Suitable solubilizing agents are anionic, nonionic or zwitterionic and amphoteric synthetic, surface-active substances.

Suitable anionic surface-active substances are:

sulfates, typically fatty alcohol sulfates, which contain 8 to 18 carbon atoms in the alkyl chain, e.g. sulfated lauryl alcohol;

fatty alcohol ether sulfates, typically the acid esters or the salts thereof of a polyadduct of 2 to 30 mol of ethylene oxide with 1 mol of a C₈-C₂₂ fatty alcohol;

the alkali metal salts, ammonium salts or amine salts of C₈-C₂₀ fatty acids, which are termed soaps, typically coconut fatty acid;

alkylamide sulfates;

alkylamine sulfates, typically monoethanolamine lauryl sulfate;

alkylamide ether sulfates;

alkylaryl polyether sulfates;

monoglyceride sulfates;

alkane sulfonates, containing 8 to 20 carbon atoms in the alkyl chain, e.g. dodecyl sulfonate;

alkylamide sulfonates;

alkylaryl sulfonates;

a-olefin sulfonates;

sulfosuccinic acid derivatives, typically alkyl sulfosuccinates, alkyl ether sulfosuccinates or alkyl sulfosuccinamide derivatives;

N-[alkylamidoalkyl] amino acids of formula

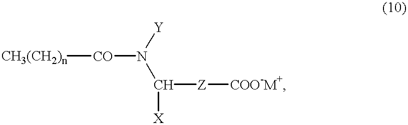

wherein

X is hydrogen, C₁-C₄ alkyl or —COO—M+,

Y is hydrogen or C₁-C₄ alkyl,

Zis:

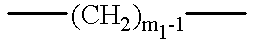

m is 1 to 5,

n₁ is an integer from 6 to 18, and

M is an alkali metal ion or an amine ion;

alkyl ether carboxylates and alkylaryl ether carboxylates of formula (10) CH₃—X—Y—A,

wherein

X is a radical:

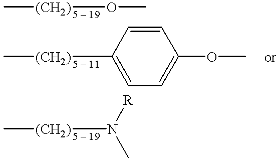

R is hydrogen or C₁-C₄ alkyl,

Y is:

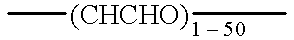

A is:

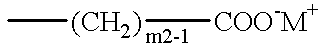

or:

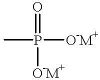

m₂ is 1 to 6, and

M is an alkali metal cation or an amine cation.

The anionic surfactants used may furthermore be fatty acid methyl taurides, alkylisothionates, fatty acid polypeptide condensates and fatty alcohol phosphoric acid esters. The alkyl radicals in these compounds preferably contain 8 to 24 carbon atoms.

The anionic surfactants are usually obtained in the form of their water-soluble salts, such as the alkali metal, ammonium or amine salts. Typical examples of such salts are lithium, sodium, potassium, ammonium, triethylamine, ethanolamine, diethanolamine or triethanol-amine salts. It is preferred to use the sodium or potassium salts or the ammonium-(NR₁R₂R₃) salts, wherein R₁, R₂ and R₃ are each independently of one another hydrogen, C₁-C₄ alkyl or C₁-C₄ hydroxyalkyl.

Very particularly preferred anionic surfactants in the novel formulation are monoethanol-amine lauryl sulfate or the alkali metal salts of fatty alcohol sulfates, preferably the sodium lauryl sulfate, sodium laureth-2 sulfate or sodium cumene sulfonate.

Suitable zwitterionic and amphoteric surfactants are imidazoline carboxylates, alkylampho-carboxy carboxylic acids, alkylamphocarboxylic acids (e.g. lauroamphoglycinate) and N-alkyl-β-aminopropionates or N-alkyl-b-iminodipropionates.

Nonionic surfactants are typically derivatives of the adducts of propylene oxide/ethylene oxide having a molecular weight of 1000 to 15000, fatty alcohol ethoxylates (1-50 EO), alkylphenol polyglycol ethers (1-50 EO), ethoxylated carbohydrates, fatty acid glycol partial esters, typically diethylene glycol monostearate, PEG5 - PEG25 glyceryl stearate, for example PEG-5 glyceryl stearate, PEG15 glyceryl stearate or PEG25 glyceryl stearate; cetearyl octanoate; fatty acid alkanolamides and fatty acid dialkanolamides, fatty acid alkanolamide ethoxylates and fatty acid amine oxides.

Furthermore, the salts of saturated and unsaturated C₈-C₂₂ fatty acids may be used as solubilizing agents, either by themselves, in admixture with each other or in admixture with the other surface-active substances cited for component (c). Illustrative examples of these fatty acids are typically capric, lauric, myristic, palmitic, stearic, arachic, behenic, dodecenoic, tetradecenoic, octadecenoic, oleic, eicosanic and erucic acid, as well as the technical mixtures of such acids, typically coconut fatty acid. These acids may be obtained in the form of salts, suitable cations being alkali metal cations such as sodium and potassium cations, metal atoms such as zinc atoms and aluminium atoms or nitrogen-containing organic compounds of sufficient alkalinity, typically amines or ethoxylated amines. These salts can also be prepared in situ.

Furthermore, suitable solubilizing agents in the present composition are dihydric alcohols, preferably those containing 2 to 6 carbon atoms in the alkylene radical, typically ethylene glycol, 1,2- or 1 ,3-propanediol, 1,3-, 1,4- or 2,3-butanediol, 1 ,5-pentanediol and 1 ,6-hexane-diol or monohydric alcohol like methanol; ethanol or propanol; and acetone.

Also mixtures of anionic, nonionic, zwifterionic, amphoteric surface-active subatances and one or more of the mono- and/or dihydric alcohols mentioned above can be used for solubilising the antimicrobial agent.

The aqueous liquor containing the antimicrobial agent (a) to (I), is prepared by first milling and then dispersing the antimicrobial agent into fine particles, or by solubilising or dispersing or dissolving in water the antimicrobial agent without milling process.

Preferably the antimicrobial agent before incorporation is dissolved in surfactants, with or without a small amount of organic solvent, other ingredients and water.

In a preferred method the aqueous liquor is heated up above the melting point of the antimicrobial agent in order to support the solubilising or dispersing process.

The aqueous liquor prepared by this method and containing the antimicrobial agent in dispersed or solubilised form can be diluted to almost any ratio.

Preferably, the antimicrobial agent is added to the aqueous liquor in an amount of 0.001 to 10% b.w., based on the fibre material.

Fibre material which can be treated with the antimicrobial agents are materials comprising for example, silk, leather, wool, polyamide, for example nylon (including nylon-6, Nylon-66), or polyurethanes, polyester, polyacrylonitrile polypropylene, polyethylene and cellulose-containing fibre materials of all kinds, for example natural cellulose fibres, such as cotton, linen, jute and hemp, and also viscose staple fibre and regenerated cellulose.

Polyester fibre materials which can be treated with the antimicrobial agents will be understood as including cellulose ester fibres such as cellulose secondary acetate and cellulose triacetate fibres and, preferably, linear polyester fibres which may also be acid-modified, and which are obtained by the condensation of terephthalic acid with ethylene gly-col or of isophthalic acid or terephthalic acid with 1 ,4-bis(hydroxymethyl)cyclohexane, as well as copolymers of terephthalic and isophthalic acid and ethylene glycol. The linear polyester fibre material (PES) hitherto used almost exclusively in the textile industry consists of terephthalic acid and ethylene glycol.

The fibre materials may also be used as blends of natural fibres like cotton, wool or jute with each other or with synthetic fibre materials like PES, Nylon or polypropylene or blends of synthetic fibre materials with each other. Typical fibre blends are of polyacrylonitrile-polyester, polyamide/polyester, polyester/cotton, polyester/viscose and polyester/wool.

The textile fibre material can be in different forms of presentation, preferably as woven or knitted fabrics or as piece goods such as knitgoods, woven fabrics nonwoven textiles, car-pets, piece garments also as yarn on cheeses, warp beams and the like or finished goods in any other form, preferably T-shirts, sport wears, running bra, sweaters, coats, lingeries, underwears and socks.

The fibres or fibre blends can be treated batchwise or continuously.

The treatment of the fibre materials is carried out from an aqueous liquor by a continuous or batch process. In batchwise dyeing, the liquor ratio may be chosen from a wide range, typically from 1:4 to 1:100, preferably from 1:5 to 1:50. The treatment temperature is not lower than 50° C. and is normally not higher than 140° C. The preferred temperature range is from 80 to 135° C.

The aqueous liquor contains the antimicrobial agent in a concentration which is sufficient to cause the agent to be exhausted into the fibre. In particular, the concentration of the antimicrobial agent is preferably form 0.01 to 10% b.w., most preferably from 0.05 to 5% b.w., based on the weight of the fibre or fabric material.

In continuous treatment methods, the treatment liquors, which may optionally contain assistants, are applied to yarns, fabric, piece goods, for example, by padding or sloppadding and are developed by thermofixation or HT steaming processes.

Linear polyester fibres and cellulose fibres are preferably treated by the high temperature process in closed and pressure-resistant apparatus at temperatures of >80° C., preferably in the range from 90 to 120° C., and at normal or elevated pressure. Suitable closed apparatus includes typically machines which are also used for dyeing processes, like circulation dyeing machines such as cheese or beam dyeing machines, winch becks, jet or drum dyeing machines, muff dyeing machines, paddles or jiggers.

Cellulose secondary acetate is preferably treated in the temperature range of from 80-85° C.

The treatment time is from 5 to 30, preferably 10 to 20 minutes.

The fibre material which is treated by the present process is characterised by having an essentially homogeneous distribution of the antimicrobial agent throughout the fibre cross-section.

The process of this invention may also be carried out together with a dyeing process. Suitable dyes are disperse dyes which are only sparingly soluble in water, metal complex dyes or acid dyes. They are therefore present in the dye liquor substantially in the form of a fine dispersion. They may belong to different dye classes, including acridone, azo, anthraquinone, coumarin, methine, perinone, naphthoquinone-imine, quinophthalone, styryl or nitro dyes. Mixtures of disperse dyes may also be used in the practice of this invention.

When using the antimicrobial agents of this invention in a dyeing process, the procedure can be such that the fibre material is first treated with these compounds and then dyeing is carried out or, preferably, the fibre material is treated simultaneously in the dyebath with the antimicrobial agent and the dye. The application of the antimicrobial agent can, however, also be effected subsequently to the previously prepared dyeing by thermofixation.

The treatment liquors may also contain further ingredients such as dyeing assistants, dispersants, carriers, wool protectives, and wetting agents as well as antifoams.

The treatment liquors may also contain mineral acids, typically sulphuric acid or phosphoric acid, or conveniently organic acids, typically including aliphatic carboxylic acids such as formic acid, acetic acid, oxalic acid or citric acid and/or salts such as ammonium acetate, ammonium sulfate or sodium acetate. The acids are used in particular to adjust the pH of the liquors used in the practice of this invention to 4-5.

The fibre material is first run into the bath which contains the antimicrobial agent, preferably the dye, and any further auxiliaries, and which has been adjusted to pH 4.5-5.5 at 20-80° C., then the temperature is raised to 80-125° C. over 20 to 40 minutes, and further treatment is carried out for 10 to 100 minutes, preferably for 20-80 minutes preferably in the temperature range of 80 to 125° C.

The samples are finished by cooling the treatment liquor to 50-80° C., optionally washing off the dyeings with water and, if necessary, reductively clearing them in conventional manner in alkaline medium. The treated samples are then again washed off and dried. When using vat dyes for dyeing the cellulose component, the goods are first treated with hydrosulfite at pH 6-12.5, then treated with an oxidising agent and finally washed off.

The process of this invention makes it possible to obtain antimicrobial finished textile materials having long lasting efficacy. The textile materials finished by the process of the present invention are advantageous with respect to inhibition of micro-organisms, reduction of the risk of contamination, reduction of odour, increase in freshness and improvement in hygienic conditions.

In the following Examples, percentages are by weight. The amounts of dye and antimicrobial agent are based on pure substance.

### EXAMPLE 1

Preparation of Antimicrobial Formulation

7.0 g of the compound of formula (101)

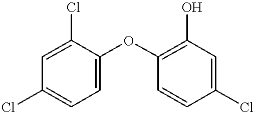

(Triclosan),

21.0 g of naphthalenesulfonic acid/formaldehyde condensation product and 112.0 g water

are mixed in a suitable vessel into which 200 g of quartz sand has been previously added. The mixture is then homogenised on a tumbling machine for 24 hours. The quartz sand is then filtered off and the formulation is ready to be used.

### EXAMPLE 2

Incorporation of the Formulation

50 ml of the formulation prepared in Example 1 are placed in a suitable vessel and are diluted with water of 1000ml, together with approximately 500 g of textile materials made from poly(ethylene terephthalate). The vessel is then sealed and placed in a bath at 120° C. for 1-5 hours. The treated textile is then removed from the formulation and rinsed thoroughly with water.

### EXAMPLE 3

Determination of Triclosan Concentration in the Textile Material

The concentration of Triclosan in the treated textile was measured by dissolving an appropriate amount of such textile material in dichloro acetic acid followed by an appropriate separation/extraction procedure, and then HPLC analysis. The concentration is found to be 0.26% of the total weight of the textiles.

### EXAMPLE 4

Extration of Treated Textiles

To determine whether Triclosan has been incorporated into the intermolecular structure or rather has been absorbed on the surface of the textile, an extraction experiment is carried out. Thus, an appropriate amount of treated textile is subjected to Soxhlet extraction by hexane, which is a good solvent of Triclosan, for 60 minutes. The concentration of Triclosan in the textiles that has undergone extraction and the extractant are analysed by HPLC respectively. It is found that the concentration of Triclosan in the fibre remains almost unchanged, whereas the amount of Triclosan in the extractant is negligible. These results demonstrate that Triclosan is incorporated into the PET fibres from which the textiles are formed.

### EXAMPLE 5

Determination of the Antimicrobial Efficacy of the Treated Fibre

The antibacterial activity of a sample has been tested in a migration test according to the Agar diffusion test.

Sample: Polyester sample LA 45

Microbiological evaluation: Determination of the bacteriostatic activity according to the bacterial growth inhibition test (modified test method CG 147).

Principle: Discs with 20 mm diameter are cut under sterile conditions and then applied on the top layer of the solidified agar containing the bacteria (from over-night cultures, an 1:100 (S. aureus) and an 1:1000 (E. coli) dilution is made and 3.5 ml are added to 500 ml agar).

After the incubation, the inhibition zones are measured and the results obtained are set out in Table 1.

Test bacteria Staphylococcus aureus ATCC 9144 Escherichia coli ATCC 11229

Nutrient medium: Casein soy meal pepton agar (two layers of agar: 15 ml bottom layer without germs and 6 ml top laye§r with bacteria)

Incubation: 18-24 hours at 37° C.

TABLE 1

| | Staphylococcus aureus | | Escherichia coli | |
|---|---|---|---|---|
| Microorganisms | ATCC 9144 | | ATCC 11229 | |
| Samples | ZI¹ | VR | ZI | VR² |
| Polyester sample with | 9/9 | 4/4 | 2/2 | 4/4 |
| Triclosan | | | | |

0 = strong growth (no activity)
4 = no growth (good activity)
¹zone of inhibition in mm
²Vinson rating for growth on the disc

### EXAMPLE 6

a. 5 g of SLS (sodium lauryl sulphate, Henkel) are dissolved in 100 ml of water. 1 g of Triclosan is then added to the solution with stirring. Preferably the solution is heated up to 60° C. to support solubilising/dispersion.

b. 5 ml of the formulation are added to 195 ml of water. 10 g of polyester fabric sample are then added to the diluted formulation and the mixture is heated up to 130° C. for 60 min. After that, the fabric is washed and the content of Triclosan in the fabric is found to be 0.47%.

### EXAMPLE 7

2.5 ml of the formulation as prepared in Example 6a is added to 195 ml of water. 10 g of a blend of cotton (40%) and polyester (60%) fabric are then added to the diluted formulation and the mixture is heated up to 130° C. for 60 min.

After that, the fabric is washed and the content of Triclosan in the fabric is found to be 0.42% in the polyester.

### EXAMPLE 8

Determination of the Antimicrobial Activity of 2 Polvester Samples Treated with Triclosan

2 polyester samples treated with Triclosan by a dyeing process are washed for 20 cycles (15 minutes each) at 2500 ppm hypochlorite (resulting in a pH of 11).

The antimicrobial efficacy of these samples is determined in an agar diffusion test according to the method CG 147 against one gram-positive and two gram-negative strains.

The PES samples containing Triclosan show excellent antibacterial effects against the gram positive Staphylococcus aureus and the gram negatives Escherichia coli and Proteus vulgaris even after 20 washes.

Microbiological Evaluation

Determination of the bacteriostatic activity according to the bacterial growth inhibition test (agar diffusion test, CG 147).

Samples

Sample 1: PES/cotton blend(60:40) with 0.25% Triclosan

Sample 2: PES/cotton blend after 20 washings

Test bacteria: Staphylococcus aureus ATCC 9144 Escherichia coli NCTC 8196 Proteus vulgaris ATCC 13315

Nutrient medium: Casein soya meal pepton agar (CASO-agar)

Incubation: at 37° C. for 24 hours (28° C. for Proteus vulgaris)

Principle:

For the preparation of the agar plates a bottom layer of 15 ml sterile agar medium is poured in petri dishes and after solidification of the agar, 6 ml of a germ-containing agar are evenly distributed on the bottom agar layer.

In order to prepare the germ-containing agar 3.5 ml of a 1:100 (Staph. aureus) and 1:1000 (E. coli and Pr. vulgaris) diluted over-night cultures of the bacteria are mixed with 500 ml molten agar at 47° C.

After solidification of the top layer, the samples of the fabric (discs with 20 mm diameter) are applied in the middle of the inoculated plates (one sample on each agar plate). Each test material is tested twice.

All plates are then incubated. After incubation the zones of inhibition around the fabric discs are measured and the growth under the discs are evaluated. The results are listed in Table 2

TABLE 2

| | Staphylococcus | | Escherichia | | | |
|---|---|---|---|---|---|---|
| | aureus | | coli | | Proteus vulgaris | |
| Microorganisms | ATCC 9144 | | NCTC 8196 | | ATCC 13315 | |
| Samples | ZI | VR | ZI | VR | ZI | VR |
| Sample 1 | 10/10 | 4/4 | 5/5 | 4/4 | 6/6 | 4/4 |
| PES/cotton blend with | | | | | | |
| 0.25% Irgasan DP 300 | | | | | | |
| Sample 2 | 5/5 | 4/4 | 2/2 | 4/4 | 0/0 | 4/4 |
| PES/cotton blend after | | | | | | |
| 20 treatments with | | | | | | |
| 2500 hypochlorite | | | | | | |

```
All samples are tested twice. Both results are given in Table 2.
Legend: ZI = Zone of inhibition around the fabric discs in millimetres
      VR = Vinson rating, for growth under the disc
      0 = growth under the disc (no activity)
      4 = no growth (very good activity)
```

L. J. Vinson et al, J. Pharm. Sci. 50, 827-830, 1961

The results clearly demonstrate that the PES/cotton blend after treatment also exhibits excellent antimicrobial activity. The good activity after 20 washings with 2500 ppm hypochlorite is remarkable.

### EXAMPLE 9

6 g of Triclosan are dissolved in 4 g of propylene glycol (solution A). 0.5 g of sodium lauryl sulfate is dissolved in 200 g of water (solution B). Then 90 mg of Solution A are added to Solution B which is heated at 60° C. The resulting mixture is a clear solution (solution C) wherein Triclosan is solubilised. 10 g of polyester fabric are added to Solution C and heated to 130° C. for 60 minutes. The PES fabric is then washed.

The concentration of Triclosan in the treated PES fabric is 0.48%.

### EXAMPLE 10

10 g of Triclosan are dissolved in a mixture of 10 g of isopropanol and 20 g of propylene glycol. To this mixture 50 g of sodium lauryl sulphate and 5 g of sodium cumenesulfonate and 5 g of water are added.

The resulting mixture is a clear solution.

### EXAMPLE 11

0.5 g of the formulation as prepared in Example 10 is added to 200 g of water. The resulting mixture is a turbid but stable emulsion. Into this mixture 10 g of Nylon 66 fabric is added and the antimicrobial treatment can be carried out at 95° C. for 60 minutes.

The nylon 66 fabric contains 0.5% of Triclosan after treatment.

### EXAMPLE 12

Incorporation of Antimicrobial into Nylon Fabrics in a Simultaneously Dyeing Process

This example the antimicrobial formulation is added together with dyestuff to Nylon 6 and nylon 66 fabrics, i.e. the treatment is carried together with the dyeing of the fabrics. The amount of antimicrobial formulation of Example 6 added is always 1 gram. The duration of treatment is always 60 minutes. Concentration of Triclosan is analysed using conditions as described in Example 3.

Liquor ratio used in the experiments is 1 :10, thus 20 grams of fabrics in 200 ml of water bath. Dyestuff used in this example are:

Lanaset Green B®: 1.0% owf

Lanaset Blue 2R®: 0.8% owf

Lanaset Bordeaux® B: 0.2% owf

Erionyl yellow® A-R: 0.6% owf

The results show that the addition of dyestuff does not influence the incorporation of antimicrobial into the fabrics. Such a process would be advantageous as antimicrobial treatment can be carried out together with dyeing. Additional processing cost for the incorporation of the desired antimicrobials into the fabrics can therefore be eliminated.

### EXAMPLE 13

Incorporation of Antimicrobial into Nylon Carpets in a Continues Process Together with Dyestuff

The majority of nylon made carpets is dyed in a continuous process involving padding the undyed carpets with dyestuff dispersed/dissolved in aqueous bath followed by steam fixation at about 100° C. for 2-10 minutes followed by spin drying, rinsing, spinning drying and oven drying. In this example, the same antimicrobial formulation as described in example 6 is incorporated into the dye bath. The dyestuffs used in this experiment are:

| | | |
|---|---|---|
| Tectilon ® Yellow 3R 200% | 1.13% | owf |
| Tectilon ® Red 23 200% | 0.464% | owf |
| Tectilon ® Blue 4R-0 200% | 0.46% | owf |

Auxilaries:

1 g/l Solvitose® OFA

3g/l Irgapadol® PN

3g/l Ammonium acetate

To this formulation, 11.5 g /l of the formulation as described in Example 6 is added. The pickup of the bath to carpet is 450%. Carpets are prewetted with Tinovetin® Ju at 1 g/l at 60° C.

In this example, two samples are prepared. One is obtained with 5 minutes of fixation time and the other with 10 minutes of fixation time. The finished carpets are analysised using the procedures as described in Example 3 for the concentration of Triclosan.

The concentration of Triclosan fixed in the carpets is found to be around 0.4% in both samples.

### EXAMPLE 14

Incorporation of Antimicrobial into Nylon Carpets in a Continues Process Together with Dyestuff.

The majority of t nylon made carpets is dyed in a continuous process involving padding the undyed carpets with dyestuff dispersed/dissolved in aqueous bath followed by steam fixation at about 100° C. for 2-10 minutes followed by spin drying, rinsing, spinning drying and oven drying. In this example, the same antimicrobial formulation as described in example 6 is incorporated into the dye bath. The dyestuffs used in this experiment are:

| | | |
|---|---|---|
| Tectilon ® Yellow 3R 200% | 1.13% | owf |
| Tectilon ® Red 23 200% | 0.464% | owf |
| Tectilon ® Blue 4R-0 200% | 0.46% | owf |

Auxilaries:

1 g/l Solvitose® OFA

3 g/l Irgapadol® PN

3 g/l Ammonium acetate

To this formulation, 11 .5 g/l of the formulation as described in Example 6 is added. The pickup of the bath to carpet is 450%. Carpets are prewetted with Tinovetin® Ju at 1 g/l at 60° C.

In this example, two samples are prepared. One is obtained with 5 minutes of fixation time and the other with 10 minutes of fixation time. The finished carpets are analysed using the procedures as described in Example 3 for the concentration of Triclosan.

The concentration of Triclosan fixed in the carpets is found to be around 0.4% in both samples.

### EXAMPLE 15

10 gram of 4,4′-dichloro-2′-hydroxy-diphenylether are dissolved in a mixture of 10 gram of isopropanol and 20g of propylene glycol. To this mixture 50 gram of sodium lauryl sulphate and 5 g of sodium cumenesulfonate and 5 gram of water are added. The resulting formulation is a clear solution.

### EXAMPLE 16

0.5 gram of the formulation as prepared in Example 15 is used to treat Nylon 66 fabrics using procedures as described in Example 11.

The treated fabric contains 0.5% of 4,4′-dichloro-2′-hydroxy-diphenylether.

1. A process for the incorporation of an antimicrobial agent into a fibre, fabric or piece goods comprising treating said material by passing said fibre into an aqueous liquor containing an antimicrobial agent selected from
(a) halogeno-o-hydroxydiphenyl compounds;
(b) phenol derivatives;
(c) benzyl alcohols;
(d) chlorohexidine and derivatives thereof;
(e) C₁₂-C₁₄ alkylbetaines and C₈-C₁₈ fatty acid amidoalkylbetaines;
(f) amphoteric surfactants;
(g) trihalocarbanilides;
(h) quaternary and polyquaternary compounds; and
(i) thiazole compounds.

2. A process according to claim 1 wherein the antimicrobial agent (a) is a compound of formula 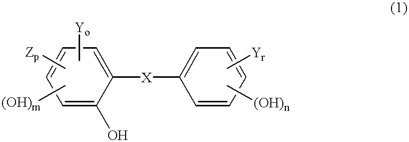
wherein
X is oxygen, sulfur or —CH₂—,
Y is chloro or bromo,
Z is SO₂H, NO₂ or C₁-C₄—Alkyl,
r is 0 to3,
o is 0 to3,
p is 0 or1,
m is 0 or 1 and
n is 0 or1;
and at least one of r or o is ≠0.

3. A process according to claim 2, wherein the antimicrobial agent (a) is a compound of formula (1), wherein
X is oxygen, sulfur or —CH₂—, and
Y is chloro or bromo,
m is 0,
n is 0 or1,
o is 1 or 2,
r is 1 or 2 and
p is 0.

4. A process according to claim 2, wherein the antimicrobial agent (a) is a compound of formula 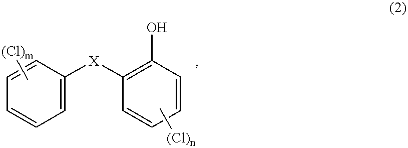
wherein
X is —O— or —CH₂—;
m is 1 to 3; and
n is 1 or2.

5. A process according to claim 1 wherein the antimicrobial agent (a) is a compound of formula

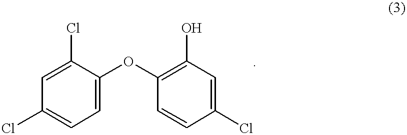

6. A process according to claim 1 wherein the antimicrobial agent (a) is a compound of formula

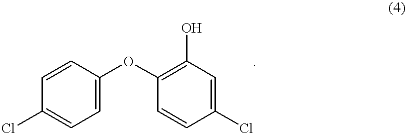

7. A process according to claim 1 wherein the antimicrobial agent (b) is a compound of the formula 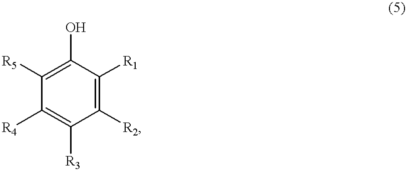
wherein
R₁ is hydrogen, hydroxy, C₁-C₄ alkyl, chloro, nitro, phenyl oder benzyl,
R₂ is hydrogen, hydroxy, C₁-C₆ alkyl or halogen,
R₃ is hydrogen, C₁-C6 alkyl, hydroxy, chloro, nitro or a sulfo group in the form of the alkali metal salts or ammonium salts thereof,
R₄ is hydrogen or methyl, and
R₅ is hydrogen or nitro.

8. A process according to claim 1 wherein the antimicrobial agent (c) is a compound of the formula 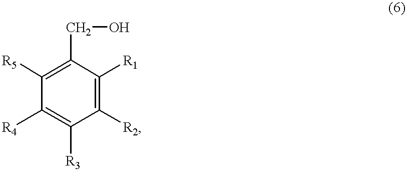
wherein
R₁, R₂, R₃, R₄ and R₅ are each independently of one another hydrogen or chloro.

9. A process according to claim 1 wherein the antimicrobial agent (g) is a compound of the formula 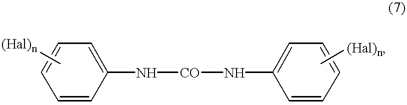
wherein
Hal is chloro or bromo,
n and m are 1 or 2, and
n+m are3.

10. A process according to claim 1 wherein the antimicrobial agent is applied as aqueous formulation in diluted, solubilised, emulsified or dispersed form.

11. A process according to claim 10, wherein the antimicrobial agent is solubilised or dispersed with an anionic, nonionic or zwitterionic and amphoteric synthetic, surface-active substance.

12. A process according to claim 1 1, wherein the surfactant is sodium cumene sulfonate or sodium lauryl sulphate.

13. A process according to claim 10 wherein the antimicrobial agent is solubilised with amono- or dihydric alcohol.

14. A process according to claim 10 wherein the antimicrobial agent is solubilised with mixtures of anionic, nonionic, zwitterionic, amphoteric surface-active substances and one or more of the mono- and/or dihydric alcohol.

15. A process according to claim 1 wherein the antimicrobial agent is ad ded to the aqueous liquor in an amount of 0.001 to 10% b.w., ba sed on the fibre material.

16. A process according to claim 1 wherein the process is carried out in a temperature range form 80° to 135° C.

17. A process according to claim 1 wherein an aqueous liquor containing antimicrobial agent before incorporation is first milled into fine particles and then dispersed, or the antimicrobial agent is solubilised or dispersed or dissolved in water without any milling process.

18. A process according to claim 17 wherein the antimicrobial agent before incorporation is dissolved in surfactants, in a small amount of organic solvent, other ingredients and water.

19. A process according to claim 17 wherein the dissolved, dispersed or solubilised antimicrobial agent is heated up above its melting point.

20. A textile material which is treated by a process as claimed in claim 1.

21. A textile material according to claim 20, wherein the material is selected from silk, leather, wool, polyamide, polyurethane, polyester, polyacrylonitrile and cellulose-containing fibre material.

22. A fibre material according to claim 20, wherein the fibre material is a blend of natural fibres with each other or with synthetic fibre materials or a blend of synthetic fibre materials with each other.
